(19) United States
(12) Patent Application Publication
(10) Pub. No.: US 2013/0324024 A1
(43) Pub. Date: Dec. 5, 2013

(54) AUTOMATED OPERATOR'S CABIN CLIMATE CONTROL

(71) Applicant: Manitowoc Crane Group France SAS, Ecully (FR)

(72) Inventors: Olaf Remmers, Wilhemshaven (DE); Martin R. Stander, Greencastle, PA (US); John Fremont Benton, Smithsburg, MD (US); Eilt-lhnke Janssen, Schortens (DE)

(21) Appl. No.: 13/903,750

(22) Filed: May 28, 2013

(30) Foreign Application Priority Data
May 29, 2012 (DE) 10 2012 208 970.5

(51) Int. Cl. B60H 1/00

(52) U.S. Cl. CPC B60H 1/00642
USPC 454/75

(57) ABSTRACT

The present invention relates to a method for climate control in an operator's cabin of a construction machine, in particular a crane, wherein the actual temperature of the air in the cabin is detected and the characteristics—in particular the volume flow, direction and/or temperature—of the air supplied to the cabin are automatically controlled on the basis of the detected actual temperature and a particular target temperature, wherein the target temperature is automatically determined on the basis of at least one variable which affects the thermal comfort of the cabin personnel. The present invention also relates to a climate control device for the cabin of a construction machine, in particular a crane comprising such a climate control device, which is configured to perform such a method.

### RELATED APPLICATION

The present patent document claims the benefit of priority to German Patent Application No. 10 2012 208 970.5, filed May 29, 2012, and entitled “AUTOMATED OPERATOR'S CABIN CLIMATE CONTROL,” the entire contents of each of which are incorporated herein by reference.

### BACKGROUND

The invention relates to a method for automated climate control in an operator's cabin of a construction machine, in particular a crane, and to a corresponding climate control device. Construction machines usually have an operator's cabin in order to provide the construction machine operator with a workspace which in particular protects against the elements. These closed cabins have to be provided with ventilation, wherein the air supplied to the cabin can be heated by means of a heater and as appropriate cooled by means of an air-conditioning unit.

### BRIEF DESCRIPTION OF THE DRAWINGS

FIG. 1—An embodiment of a climate control device in accordance with the invention.

FIG. 2—A flow chart of an embodiment of a method in accordance with the invention.

### DETAILED DESCRIPTION

Due to the necessary large-area cabin windows and the fact that the workspace is situated relatively near to the cabin walls, it is not possible to ensure that a room temperature which is agreeable to the personnel is achieved inside the cabin, despite a heater and an air-conditioning unit. In particular during machine operations lasting a longer period of time, for example over the course of the day, it is then necessary to repeatedly re-adjust the temperature setting of the heater and/or air-conditioning unit. So-called “automatic air-conditioning units” are also known which adjust the temperature of the air supplied to the cabin to a pre-set value, but which likewise cannot in this way ensure that the cabin personnel will find the cabin air temperature agreeable.

It is the object of the present invention to provide a method and device which ensure a cabin temperature which the cabin personnel find agreeable during machine operations.

This object is solved by the subject-matter of independent patent claims 1 and 10, wherein the dependent claims advantageously develop the subject-matter in accordance with the invention.

In accordance with the present invention, the actual temperature of the air in the cabin is detected by means of at least one sensor, and characteristics—in particular the volume flow, direction and/or temperature—of the air supplied to the cabin are automatically controlled on the basis of the detected actual temperature and a particular target temperature, wherein the target temperature is automatically determined on the basis of at least one variable which affects the thermal comfort of the cabin personnel.

The so-called thermal comfort is achieved in a given indoor climate when the heat balance of the body, at a core body temperature of about 37° C., is at equilibrium. The thermal comfort is correspondingly not a variable which can be computed exactly, but is rather dependent on the subjective sensation of each individual person. It is therefore not the rule that all the people situated in a space will find the indoor climate comfortable. In accordance with DIN EN ISO 7730, a so-called “acceptable indoor climate” is defined as an environment which at least 80% of the people located there find thermally acceptable.

Almost completely ensuring the thermal comfort (acceptance by more than 80% of the people) in an operator's cabin requires the incorporation of the following basic variables: air temperature; thermal radiation; flow velocity of the air; humidity; wherein the following variables additionally affect the thermal comfort: heat insulation of clothing; metabolic heat production.

In other words, the temperature of the air supplied to the cabin is controlled in accordance with the present invention not only on the basis of a detected actual temperature and a fixed target temperature, but rather the temperature of the air supplied to the cabin is also based indirectly on other variables, i.e. by calculating a target temperature on the basis of these variables. Since these variables can change over the duration of the machine operations, the target temperature determined from them also therefore changes, which in turn affects the temperature of the air supplied to the cabin.

In addition to the temperature of the air supplied, other characteristics of the air supplied can also be varied in accordance with the invention, likewise on the basis of the variables which affect the thermal comfort of the cabin personnel.

The orientation of ventilating nozzles can for example be varied such that the air flow supplied to the cabin is prevented from flowing onto the cabin personnel's bare skin, which he or she might find disagreeable. Dehumidifying the air supplied would likewise be conceivable in order to avoid any sense of mugginess.

In accordance with a preferred embodiment of the present invention, at least one of the following variables is taken into account when determining the target temperature: the air temperature outside the cabin; the thermal radiation to which the cabin personnel is exposed; the flow velocity of the cabin air; the humidity of the cabin air; the metabolic heat production of the cabin personnel; and/or the heat insulation of the cabin personnel's clothing.

In other words, the target temperature of the cabin air can be determined in accordance with the present invention on the basis of these variables individually or on the basis of all of these variables.

The air temperature outside the cabin affects the thermal comfort of the cabin personnel in that when the outside temperature is higher/lower (summer/winter), the cabin personnel will find a predetermined cabin air temperature not as high/low as when the outside temperature is lower/higher (winter/summer).

Since operator's cabins must by their very nature offer a good outward view, they always have large window areas, which in turn increase the cabin personnel's exposure to thermal radiation from the sun. The cabin personnel are also exposed to thermal radiation from components which are for example heated by the sun. The present invention enables the cabin air temperature to be automatically reduced when the exposure to thermal radiation is higher, in order to maintain the temperature as “perceived” by the cabin personnel and therefore the thermal comfort.

Since air is a thermal insulator, the flow velocity of the cabin air likewise affects the “perceived” temperature, since the boundary layer heated by the body of the cabin personnel is dissipated by passing air and the perceived temperature is increased or reduced depending on the temperature of the passing air.

It is also possible in accordance with the invention to control the target temperature as a function of the humidity of the cabin air and/or the air supplied to the cabin. The temperature can for example be reduced when the humidity is high, in order to avoid any sense of mugginess.

In order to cater to the thermal comfort of different people, the target temperature can also be determined on the basis of the metabolic heat production of the respective cabin personnel, since the thermal comfort depends on the size and weight of the cabin personnel as well as on their activities.

The target temperature can also be made dependent on the heat insulation of the cabin personnel's clothing, in order for example to ensure the thermal comfort of the cabin personnel in both summer and winter, when corresponding clothing is worn.

The climate comfort model presented in the following provides a representative predicted value for the sensation of heat and/or cold as the degree of human discomfort in a living, working or meeting space. The PMV (predicted mean vote on climate comfort) serves as the unit of measure in this model. The PMV index describes the expected climate assessment by a group of people on the basis of an assessment scale comprising seven classes, wherein the state of thermal comfort is expressed by the neutral vote “0”.

Indoor climate assessed as being

| too warm | warm | slightly warm | neutral | slightly cool | cool | cold |
|---|---|---|---|---|---|---|
| 3 | 2 | 1 | 0 | −1 | −2 | −3 |

The PMV index can be calculated in accordance with the invention on the basis of Equations (1) to (4):

$$\begin{matrix} PMV = [ 0.303 \cdot exp ( - 0.036 \cdot M ) + 0.028 ] \\ \{ \begin{matrix}\begin{matrix}( M - W ) - 3.05 \times {10}^{- 3} [ 5733 - 6.99 ( M - W ) - {p}_{a} ] - \\ 0.42 [ ( M - W ) - 58.15 ]\end{matrix} \\ - 1.7 \times {10}^{- 5} M ( 5867 - {p}_{a} ) - 0.0014 M ( 34 - {t}_{a} ) \\ - 3.96 \times {10}^{- 8} {f}_{cl} [ {( {t}_{cl} + 273 )}^{4} - {( {\overline{t}}_{r} + 273 )}^{4} ] - {f}_{cl} {h}_{c} ( {t}_{cl} - {t}_{a} )\end{matrix} \} & ( 1 ) \\ {t}_{cl} = 35.7 - 0.028 ( M - W ) - {I}_{cl} \{ \begin{matrix}3.96 \times {10}^{- 8} {f}_{cl} [ {( {t}_{cl} + 273 )}^{4} - {( {\overline{t}}_{r} + 273 )}^{4} ] + \\ {f}_{cl} {h}_{c} ( {t}_{cl} - {t}_{a} )\end{matrix} \} & ( 2 ) \\ {h}_{c} = \{ \begin{matrix}2.38 \cdot {\vert {t}_{cl} - {t}_{a} \vert}^{0.25} \\ 12.1 \cdot \sqrt{{v}_{ar}}\end{matrix} for \begin{matrix}2.38 \cdot {\vert {t}_{cl} - {t}_{a} \vert}^{0.25} > 12.1 \cdot \sqrt{{v}_{ar}} \\ 2.38 \cdot {\vert {t}_{cl} - {t}_{a} \vert}^{0.25} < 12.1 \cdot \sqrt{{v}_{ar}}\end{matrix} & ( 3 ) \\ {f}_{cl} = \{ \begin{matrix}1.00 + 1.290 {I}_{cl} \\ 1.05 + 0.645 {I}_{cl}\end{matrix} for \begin{matrix}{I}_{cl} \leq 0.078 {m}^{2} \cdot K \text{/} W \\ {I}_{cl} > 0.078 {m}^{2} \cdot K \text{/} W\end{matrix} & ( 4 )\end{matrix}$$

where:
M is the energy expenditure of the person [W/m²]
W is the effective mechanical output [W/m²] generally, however, W=0 can be applied
I_{cl} is the clothing insulation factor [m²×K/W]
f_{cl} is the clothing surface area factor
tₐ is the air temperature [° C.]
tᵣ is the mean radiation temperature [° C.]
vₐᵣ is the relative air velocity [m/s]
pₐ is the partial pressure of water vapour [Pa]
t_{cl} is the convective heat transfer coefficient [W/(m²×K)]
t_{cl} is the surface temperature of the clothing [° C.].

Proceeding on the basis of the predicted mean vote, it is possible to determine the predicted percentage dissatisfied (“PPD”). Once the PMV value has been ascertained, the percentage of people who will find a particular ambient climate too warm (PMV=2 to 3) or too cold (PMV=−2 to −3) can be ascertained on the basis of the following equation:

PPD=100−95·e^{(0.03353·PMV}^{⁴}^{+0.2179·PMV}^{²}⁾

In accordance with a preferred embodiment of the present invention, the value of the at least one variable is measured by means of at least one suitable sensor inside and/or outside the cabin or is predefined by the user.

The air temperature inside or outside the cabin can then be easily measured using temperature sensors inside and/or outside the cabin, and the thermal radiation which the cabin personnel is exposed to, the flow velocity of the cabin air and the humidity of the cabin air can also be measured using correspondingly suitable sensors. It is conceivable to determine the metabolic heat production of the cabin personnel using temperature sensors worn for example on the skin, or for instance using infrared cameras which capture a heat image of the cabin personnel. The heat insulation of the cabin personnel's clothing could also be measured using temperature sensors on the inside and/or outside of the clothing or could also be inputted manually by the cabin personnel. The cabin personnel could for example select the clothing they are wearing by means of an input device, for example a keyboard, from which the system could determine the heat insulation of the clothing from tables.

It is also conceivable to detect the actual temperature and/or the value of the at least one variable at a number of mutually spaced locations inside and/or outside the cabin. In this way, the air temperature could for example be detected in the region of the cabin personnel's head and simultaneously in the region of the cabin personnel's feet, which would enable the system to check whether the cabin personnel might for instance find the cabin air too cold in the region of their feet or too warm in the region of their head.

It would also be conceivable to determine the target temperature for mutually spaced cabin locations. In this way, it would for example be possible to generally provide a lower target temperature of the cabin air in the region of the head than in the region of the feet.

In accordance with another preferred embodiment, it would be conceivable to provide a so-called “override” mode which enables the cabin personnel to adapt the characteristics of the air supplied to the cabin, in particular the volume flow, direction and/or temperature, to individual preferences. In accordance with another preferred embodiment, it is also conceivable to additionally take into account at least one of the following parameters when controlling the characteristics, in particular the volume flow and/or direction and/or temperature, of the air supplied to the cabin, wherein values for it/them are in particular detected by means of at least one suitable sensor inside and/or outside the cabin or are predefined by the user: at least one cabin pane misting up; the CO₂ content in the cabin air; the content of pollutants in the cabin air or outside air; cooling the air in the cabin as quickly as possible; heating the air in the cabin as quickly as possible.

Thus, the present invention also offers the option of meeting other demands, in addition to ensuring the thermal comfort of the cabin personnel, and correspondingly controlling the characteristics of the air supplied to the cabin.

In accordance with another preferred embodiment, at least one of these parameters can be ranked higher or lower than the thermal comfort when controlling the characteristics, in particular the volume flow, direction and/or temperature, of the air supplied. In other words, the volume flow of air supplied to the cabin can for example be increased when the CO₂ content in the cabin air is higher, even though this would be detrimental to the thermal comfort of the cabin personnel.

It would also be conceivable to indicate instructions for achieving a target state to the cabin personnel, for example on a display, wherein “target state” does not refer to the target temperature of the cabin air only but rather can also relate to the aforementioned parameters, i.e. at least one cabin pane misting up (as measured for example by a moisture sensor on a pane), the CO₂ content in the cabin air, the content of pollutants in the cabin air, or cooling/heating the air in the cabin as quickly as possible. In order to cool/heat the cabin air as quickly as possible, for example, the cabin personnel could be instructed to close the cabin windows, or when the content of pollutants in the cabin air or outside air is too high, the cabin personnel could be instructed to open or close the cabin windows, respectively.

It would also be conceivable to store individual values for the characteristics, in particular the volume flow, direction and/or temperature, of the air supplied to the cabin for particular individuals within the cabin personnel, in order to be subsequently retrieved. It would therefore be possible to provide an agreeable climate in the operator's cabin to different crane operators, without them having to manually input individual variables such as for example the heat insulation of the clothing they are currently wearing. It would then be conceivable for each crane operator to inform the system, by means of a keystroke, that the characteristics of the air supplied to the cabin are to be adapted to that individual.

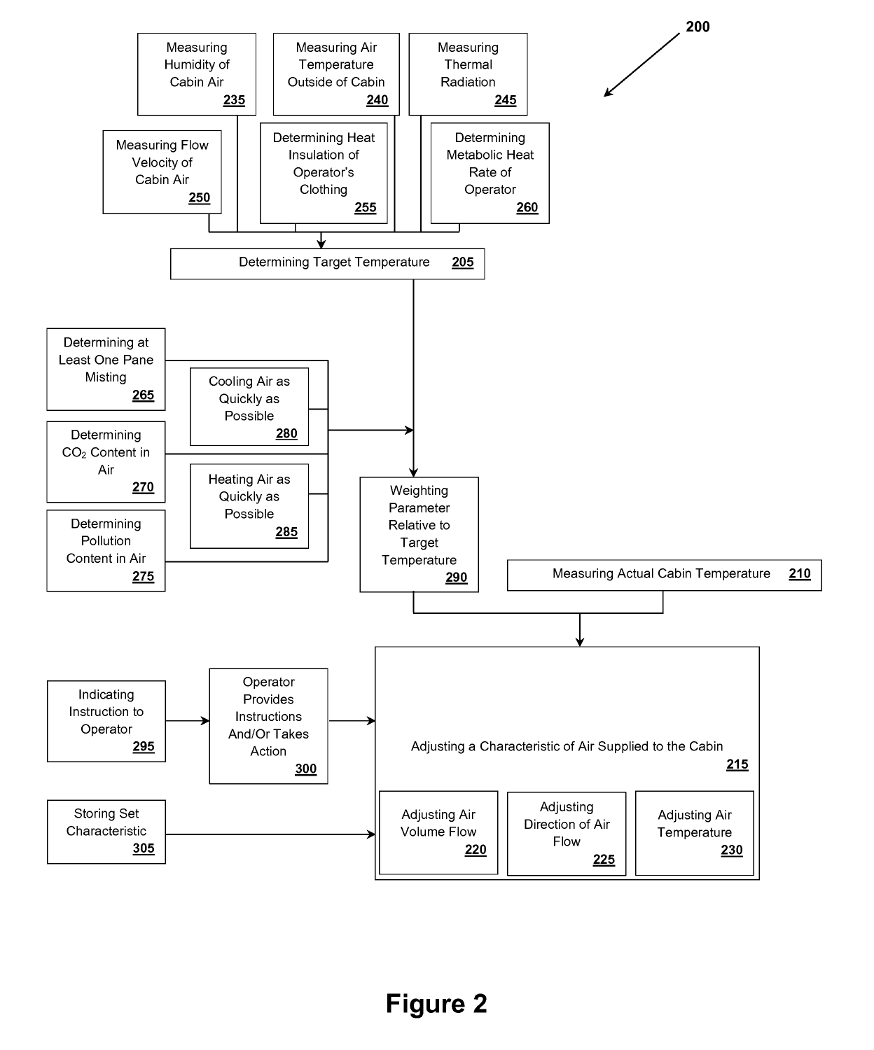

Illustrated in FIG. 2 is a flow chart 200 of an embodiment of the invention as described above. The method includes determining a target temperature 205, measuring the actual temperature 210, and adjusting a characteristic of the air supplied to cabin, 215. The adjusting step 215 optionally includes adjusting the air volume flow 220, adjusting the direction of the air flow 225, and adjusting the air temperature of the air supplied to the cabin 230.

The step of determining the target temperature 205 optionally includes one or more of the steps of measuring the humidity of the cabin air 235, measuring the air temperature outside of the cabin 240, measuring the thermal radiation 245, measuring the flow velocity of the cabin air 250, determining the heat insulation of the operator's clothing 255, and determining the metabolic heat rate of the operator 260, each as described above.

The step of adjusting a characteristic of the air supplied to the cabin 215 optionally includes evaluating and weighting one or more additional parameters. These parameters include determining whether or not at least one pane is misting 265, determining the CO₂ content in the air 270, determining the pollution content in the air 275, cooling the air as quickly as possible 280, and heating the air as quickly as possible 285. One or more of these parameters are then weighted relative to the target temperature 290.

The method optionally includes indicating an instruction or modification to air supplied to the operator, 295 to achieve a target state. The operator then can act in accordance with the instructions or provide instructions to adjust a characteristic 300. Further, a value for a characteristic optionally is stored 305 for subsequent retrieval, such as a previously stored characteristic for a specific operator.

Another aspect of the present invention relates to a climate control device for the cabin of a construction machine, in particular a crane, which is configured to perform a method such as has been described above.

Such a climate control device comprises at least one ventilation device for supplying air to the cabin and at least one sensor for measuring—or an input interface for manually inputting—variables which influence the thermal comfort of the cabin personnel. The climate control device in accordance with the invention can also comprise a heater and/or an air-conditioning unit in order to control the temperature and humidity of the air supplied to the cabin.

The control device comprises a micro-controller which is connected to suitable sensors, for example the sensors described above, and which records their measurement values. The micro-controller is on the other hand connected to the fan, air-conditioning unit and heater of an air supply device and controls them on the basis of the measurement values provided by the sensors. By means of a CAN bus, the cabin personnel is given the option of making inputs by means of a keyboard, wherein an indicating option is also provided, for example by way of a display.

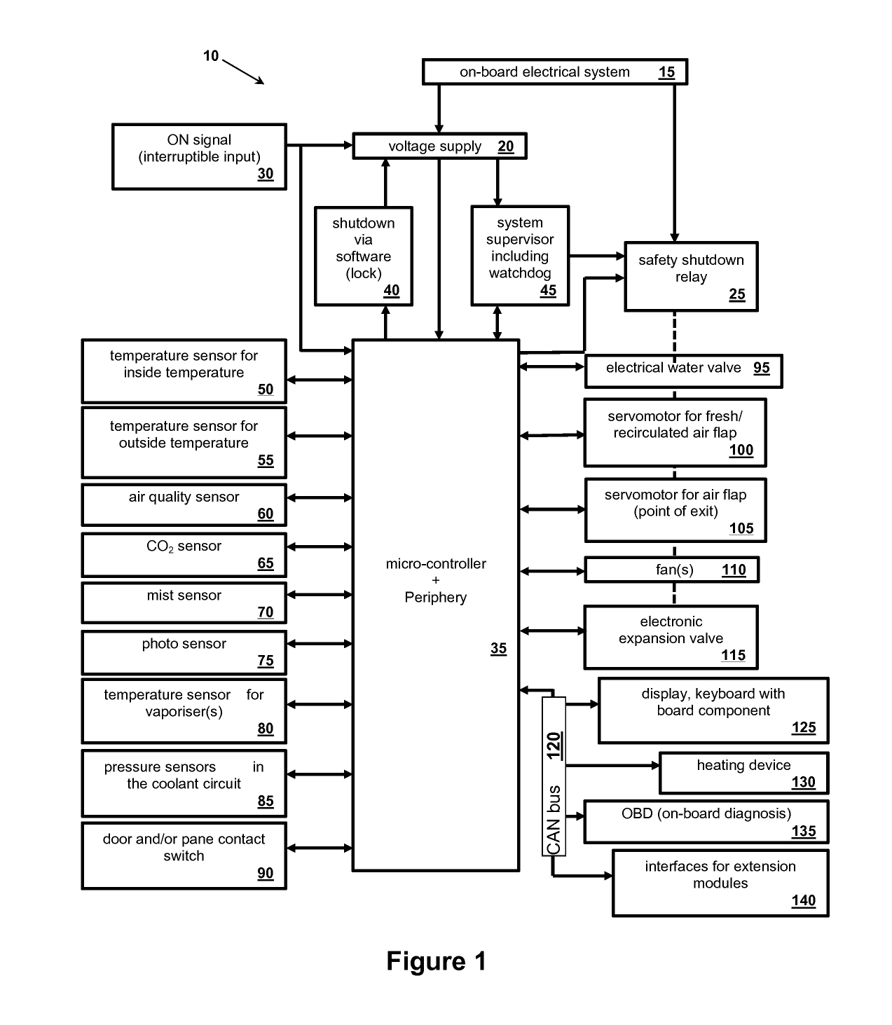

Illustrated in FIG. 1 is a diagram of an embodiment of an automated climate control system 10 for an operator's cabin of a construction machine, such as a crane. The climate control system 10 includes an on-board electrical system 15 connected to a voltage supply and a safety shutdown relay 25. An ON signal or switch 30, which is an interruptible input, is connected to the voltage supply 20 and a micro-controller 35, which may include a periphery. The micro-controller 35 is connected to a software lock/shutdown 40, which in turn connects to the voltage supply 20. Similarly, the voltage supply 20 connects directly to the micro-controller 35, as well as through an intermediary system supervisor 45 that includes a watchdog that is connected to both the micro-controller 35 and the voltage supply 20. The micro-controller 35 and the system supervisor 45 are both at least separately connected to the safety shutdown relay 25.

The micro-controller 35 optionally is connected to several sensors, including at least one of a temperature sensor 50 to measure the temperature inside of the operator's cabin; a temperature sensor 55 to measure the temperature outside of the operator's cabin; an air quality or pollution sensor 60; a carbon dioxide (CO₂) sensor 65; a mist sensor 70; a photo sensor 75, which in some embodiments, as would be understood from this disclosure, is suitable to detect thermal radiation and/or a metabolic rate with, for example, an infrared camera; a temperature sensor 80 for at least one vaporizer; at least one pressure sensor 85 in a coolant circuit; and a door and/or pane contact switch 90.

The micro-controller optionally is connected to several control mechanisms, including at least one of an electrical water valve 95; a servomotor for a fresh/recirculated air flap 100; a servomotor for an air flap that provides a point of exit for air 105; at least one fan 110; and an electronic expansion valve 115. The safety shutdown relay 25 optionally is connected to at least one of the electrical water valve 95; the servomotor for a fresh/recirculated air flap 100; the servomotor for an air flap that provides a point of exit for air 105; the at least one fan 110; and the electronic expansion valve 115.

The micro-controller 95 optionally is connected to a CAN bus 120, which in turn connects the microcontroller 95 to at least one of a display and/or keyboard with board components 125; a heating device 130; on-board diagnostics (OBD) 135; and at least one interface for extension modules 140.

The present invention can comprise any of the features shown here, individually and in any expedient combination.

1. A method for climate control in an operator's cabin of a construction machine, in particular a crane, wherein an actual temperature of air in the cabin is detected by at least one sensor, and at least one characteristic of air supplied to the cabin is automatically controlled on a basis of the actual temperature and a target temperature, characterised in that the target temperature is automatically determined on a basis of at least one variable which affects a thermal comfort of a cabin personnel.

2. The method in accordance with claim 1, wherein the at least one characteristic of the air supplied to the cabin is selected from a group consisting of a volume flow, a direction, and a temperature.

3. The method in accordance with claim 1, wherein the at least one variable which affects the thermal comfort is selected from a group consisting of:
an air temperature outside of the cabin;
a thermal radiation to which the cabin personnel is exposed;
a flow velocity of the cabin air;
a humidity of the cabin air;
a metabolic heat production of the cabin personnel; and,
a heat insulation of a clothing worn by the cabin personnel.

4. The method in accordance with claim 3, wherein a value of the at least one variable is determined by at least one of being measured by at least one sensor inside the cabin, being measured by at least one sensor outside of the cabin, and being predefined by the cabin personnel.

5. The method in accordance with claim 4, wherein at least one of the actual temperature and the value of the at least one variable is detected at a number of mutually spaced locations in at least one of the inside and the outside of the cabin.

6. The method in accordance with claim 1, wherein the target temperature is determined for a number of mutually spaced cabin locations.

7. The method in accordance with claim 1, wherein at least one parameter is taken into account when controlling the at least one characteristic and wherein a value for the at least one parameter is determined by at least one of being measured by at least one sensor inside the cabin, being measured by at least one sensor outside of the cabin, and being predefined by the cabin personnel, the at least one parameter being selected from a group consisting of:
at least one cabin pane misting up;
a CO2 content in the cabin air;
a content of pollutants in the cabin air;
a content of pollutants in the outside air;
a cooling of the air in the cabin as quickly as possible; and,
a heating of the air in the cabin as quickly as possible.

8. The method in accordance with claim 7, wherein the at least one parameter is ranked higher or lower than the thermal comfort when controlling the at least one characteristic of the air supplied.

9. The method in accordance with any claim 1, wherein at least one instruction for achieving a target state are indicated to the cabin personnel.

10. The method in accordance with claim 1, wherein an option is provided of storing an individually set value for the at least one characteristic of the air supplied to the cabin so that the at least one characteristic can be subsequently retrieved.

11. A climate control device for the cabin of a construction machine, in particular a crane, which is configured to perform a method in accordance with claim 1.

12. A method of controlling a quality of air in an operator's cabin of a construction machine, comprising:
measuring an actual temperature of said air in said cabin;
determining a target temperature of said air in said cabin, wherein said target temperature is a function of at least one variable that affects a thermal comfort of a cabin personnel;
providing a supply of air to the cabin; and,
adjusting at least one characteristic of said supply of air, wherein said characteristic is selected from a group consisting of a volume flow, a direction, and a temperature.

13. The method of claim 12, wherein said at least one variable is selected from a group consisting of an air temperature outside of said cabin; a thermal radiation to which said cabin personnel is exposed; a flow velocity of said air in said cabin; a humidity of said air in said cabin; a metabolic heat production of said cabin personnel;
and a heat insulation of a clothing worn by said cabin personnel.

14. The method of claim 12, further comprising at least one of measuring a value of said at least one variable by at least one sensor inside the cabin, measuring a value of said at least one variable by at least one sensor outside of the cabin, and predefining a value of said at least one variable by said cabin personnel.

15. The method of claim 12, further comprising measuring said actual temperature at a number of mutually spaced locations in at least one of inside said cabin and outside of said cabin.

16. The method of claim 14, further comprising at least one of measuring said value of said at least one variable and predefining said value of said at least one variable at a number of mutually spaced locations in at least one of inside said cabin and outside of said cabin.

17. The method of claim 12, wherein determining said target temperature further comprises determining said target temperature for a number of mutually spaced cabin locations.

18. The method of claim 12, further comprising:
at least one of: measuring a parameter by at least one sensor inside of said cabin, measuring a parameter by at least one sensor outside of said cabin, and predefining a parameter by said cabin personnel, wherein said parameter is selected form the group consisting of at least one cabin pane misting up; a CO₂ content in said air in said cabin; a content of pollutants in at least one of said air of said cabin and said outside air; a cooling of said air in said cabin as quickly as possible; and a heating of said air in said cabin as quickly as possible; and,
accounting for said parameter when adjusting said at least one characteristic.

19. The method of claim 18, further comprising ranking said parameter relative to said target temperature and accounting for said ranking when adjusting said at least one characteristic of said supply of air.

20. A system of controlling a quality of air in an operator's cabin of a construction machine, comprising:
a first sensor to measure an actual temperature of said air in said cabin;
at least another sensor configured to measure a variable selected from a group consisting of an air temperature outside of said cabin; a thermal radiation to which a cabin personnel is exposed; a flow velocity of said air in said cabin; a humidity of said air in said cabin; a metabolic heat production of said cabin personnel; and a heat insulation of a clothing worn by said cabin personnel;
a micro-controller connected to said first sensor and said another sensor, said micro-controller configured to:
determine a target temperature of said air in said cabin as a function of said variable; and,
adjust at least one characteristic of a supply of air to said cabin, wherein said characteristic is selected from a group consisting of a volume flow, a direction, and a temperature.

21. The system of claim 20, wherein said construction machine comprises a crane.
